(19) United States
(12) Patent Application Publication
(10) Pub. No.: US 2024/0419420 A1
(43) Pub. Date: Dec. 19, 2024

(54) SYSTEMS AND METHODS FOR SOFTWARE APPLICATION DEPLOYMENT

(71) Applicant: DELL PRODUCTS L.P., Round Rock, TX (US)

(72) Inventors: Arun Kumar RAVICHANDRAN, Chennai (IN); Koyyana SRAVANI, Andhra Pradesh (IN); Achyutha VISHNUVARDHAN, Andhra Pradesh (IN); Soumyasri RADHAKRISHNAN, Chennai (IN); Kavitha GOVINDASAMI, Chennai (IN); Pooja Miri SAXENA, Gwalior (IN)

(73) Assignee: DELL PRODUCTS L.P., Round Rock, TX (US)

(21) Appl. No.: 18/334,233

(22) Filed: Jun. 13, 2023

(51) Int. Cl. G06F 8/61

(52) U.S. Cl. CPC G06F 8/61

(57) ABSTRACT

Embodiments herein provide a software application deployer (SAD) system or bot that can automate installation of a software package, whether as new software or an upgrade. In one or more embodiments, a SAD bot automatically identifies a type of input software package and deploys an appropriate deployer. A SAD bot may be used in various scenarios such as customer environments and engineering environments. Because the SAD bot is automated, the overall process may be performed with minimal human involvement. Following automatic deployment of a software package by a SAD bot, in one or more embodiments, a user/admin can directly start using the installed or upgraded application via a GUI (graphical user interface)/console/SSH (secure shell for Unix).

### BACKGROUND

### A. Technical Field

The present disclosure relates generally to information handling systems. More particularly, the present disclosure relates to automating the deployment of software.

### B. Background

The subject matter discussed in the background section shall not be assumed to be prior art merely as a result of its mention in this background section. Similarly, a problem mentioned in the background section or associated with the subject matter of the background section should not be assumed to have been previously recognized in the prior art. The subject matter in the background section merely represents different approaches, which in and of themselves may also be inventions.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Manual software installations, whether updates or new installations, can be problematic for several reasons. First, such processes are typically time-consuming and labor-intensive-especially in large-scale software environments with numerous systems and applications to update. Manual processes can result in delays, increased workload, and reduced productivity as IT staff manually update software components.

Second, manual software installations can be error-prone, as it relies on human intervention, which can lead to mistakes such as installing the wrong versions, trying to install software on a system with the wrong configuration, missing critical updates, or introducing configuration errors. These errors can result in system instability, security vulnerabilities, and even data breaches, which can have serious consequences for an organization's operations and security posture.

Third, manual software installations can be challenging to coordinate and manage across different systems, applications, and environments. Keeping track of various software versions, dependencies, and compatibility requirements can be complex, and ensuring that all systems are updated in a timely and consistent manner can be difficult to achieve, leading to inconsistencies and potential conflicts.

Finally, manual software updating can disrupt normal business operations, as it often requires system downtime or maintenance windows, which can impact productivity, customer service, and revenue generation. Coordinating updates during non-peak hours or scheduling downtime can be logistically challenging and may result in service disruptions that negatively affect users and customers.

Accordingly, what is needed are systems and methods for installing software in more automated and systematic ways.

### BRIEF DESCRIPTION OF THE DRA WINGS

References will be made to embodiments of the disclosure, examples of which may be illustrated in the accompanying figures. These figures are intended to be illustrative, not limiting. Although the accompanying disclosure is generally described in the context of these embodiments, it should be understood that it is not intended to limit the scope of the disclosure to these particular embodiments. Items in the figures may not be to scale.

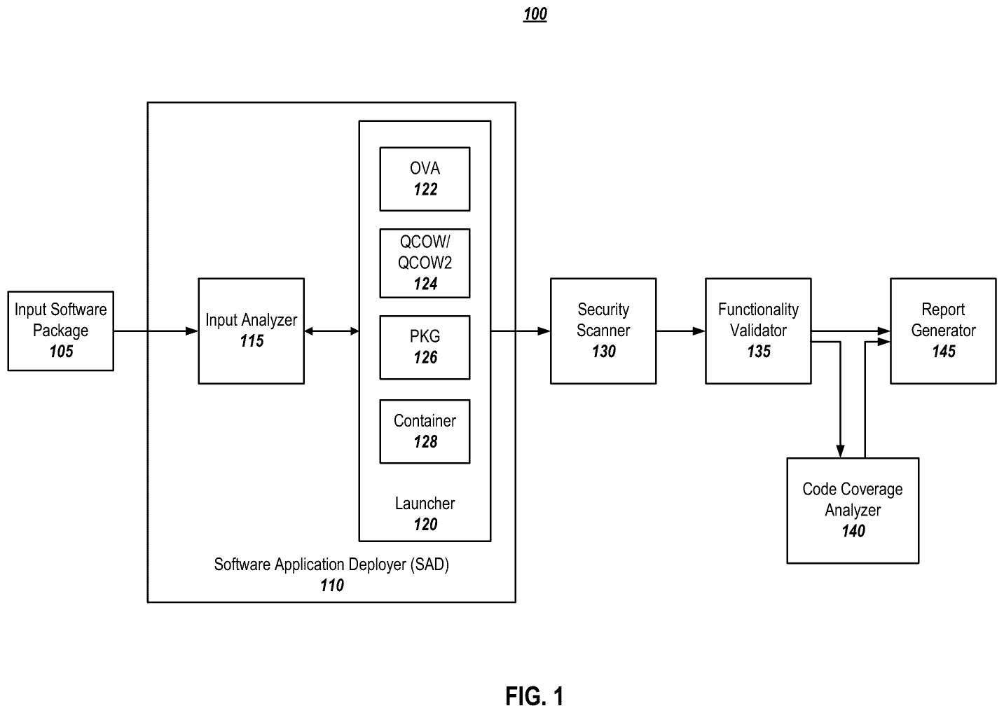

FIG. 1 (“FIG. 1”) depicts a software application deployer (SAD) system, according to embodiments of the present disclosure.

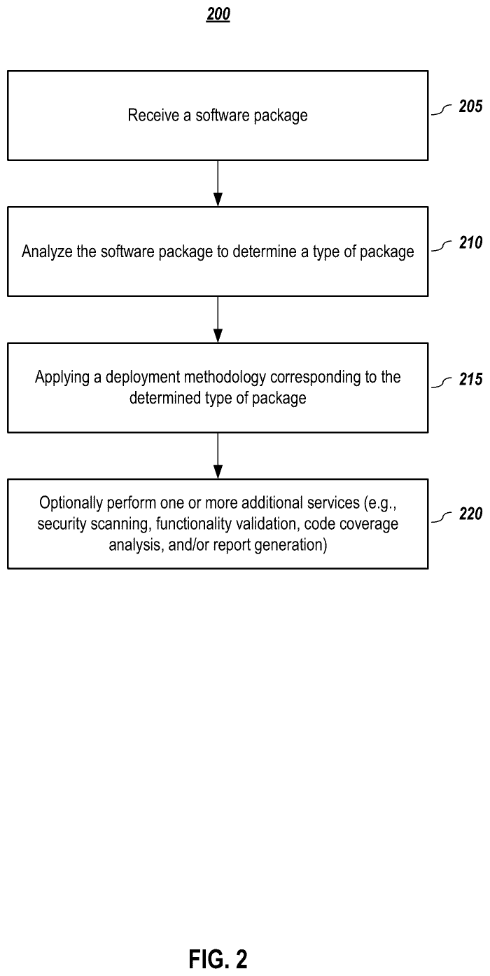

FIG. 2 depicts a methodology for software installation using a SAD system, according to embodiments of the present disclosure.

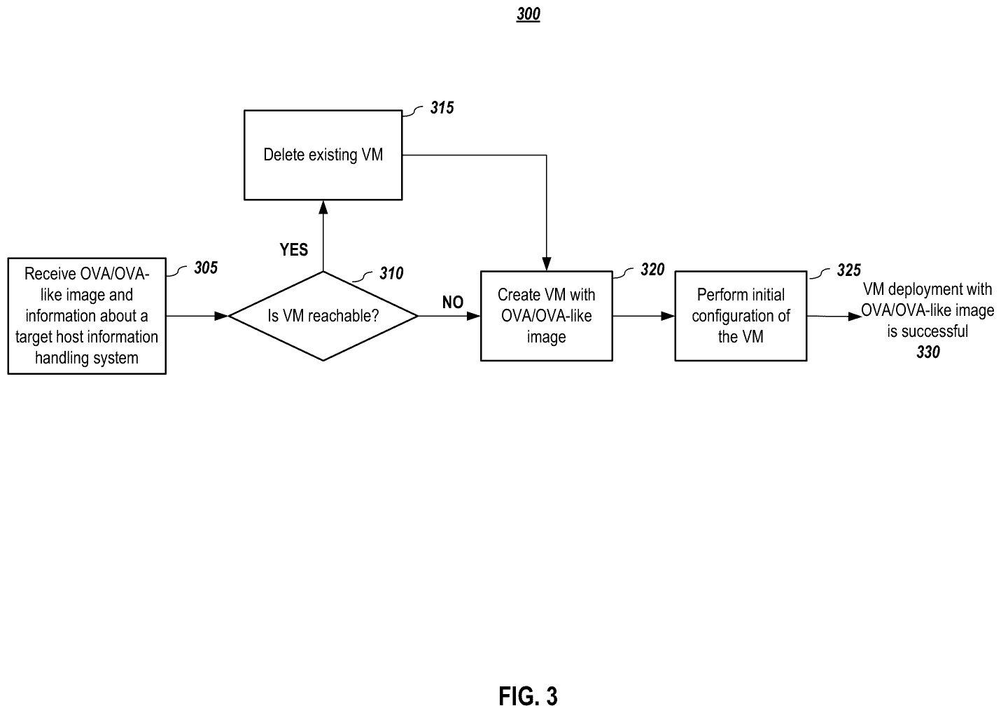

FIG. 3 depicts a methodology for software installation using a SAD system given an OVA (Open Virtualization Appliance) or OVA-like software package, according to embodiments of the present disclosure.

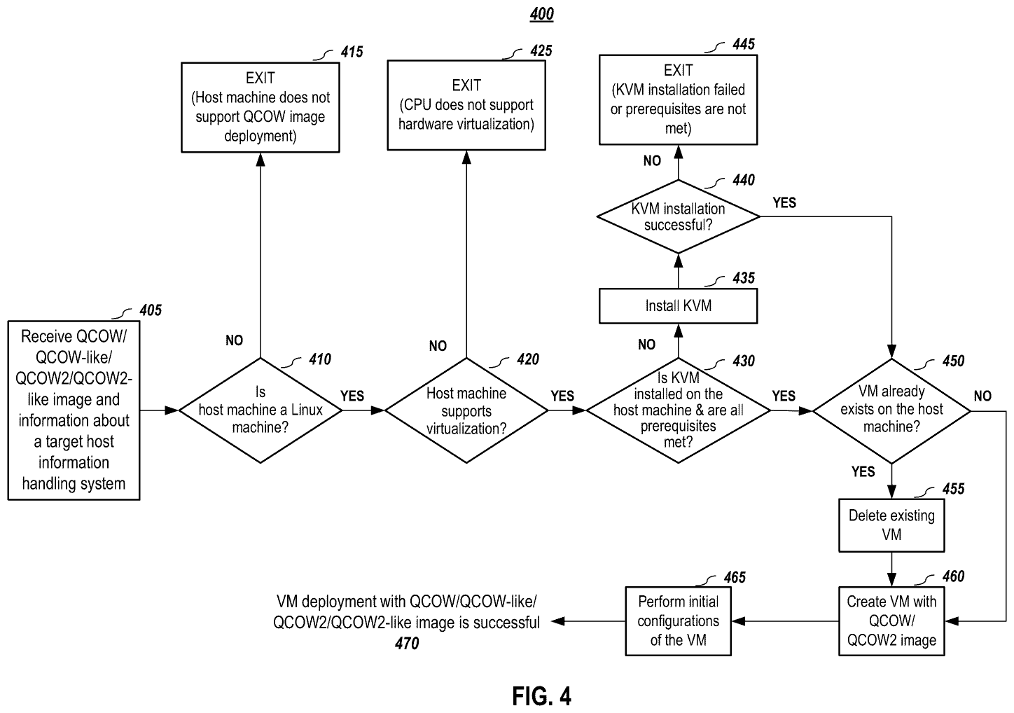

FIG. 4 depicts a methodology for software installation using a SAD system given a QCOW/QCOW2 (Quick EMUlator Copy-On-Write) or QCOW-like/QCOW2-like software package, according to embodiments of the present disclosure.

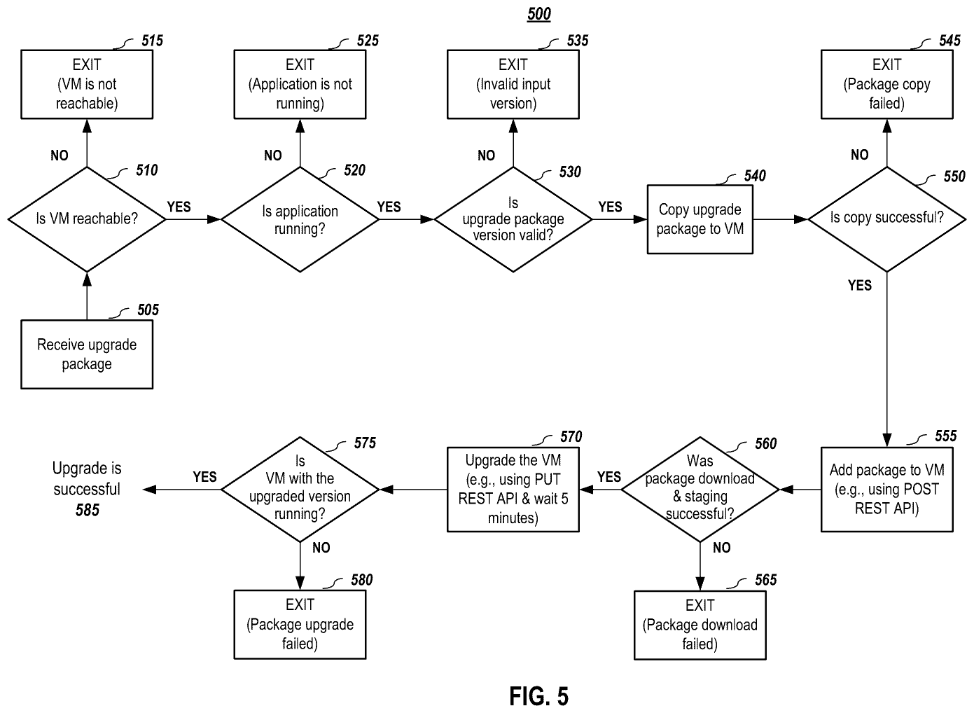

FIG. 5 depicts a methodology for software installation using a SAD system given a software package upgrade, according to embodiments of the present disclosure.

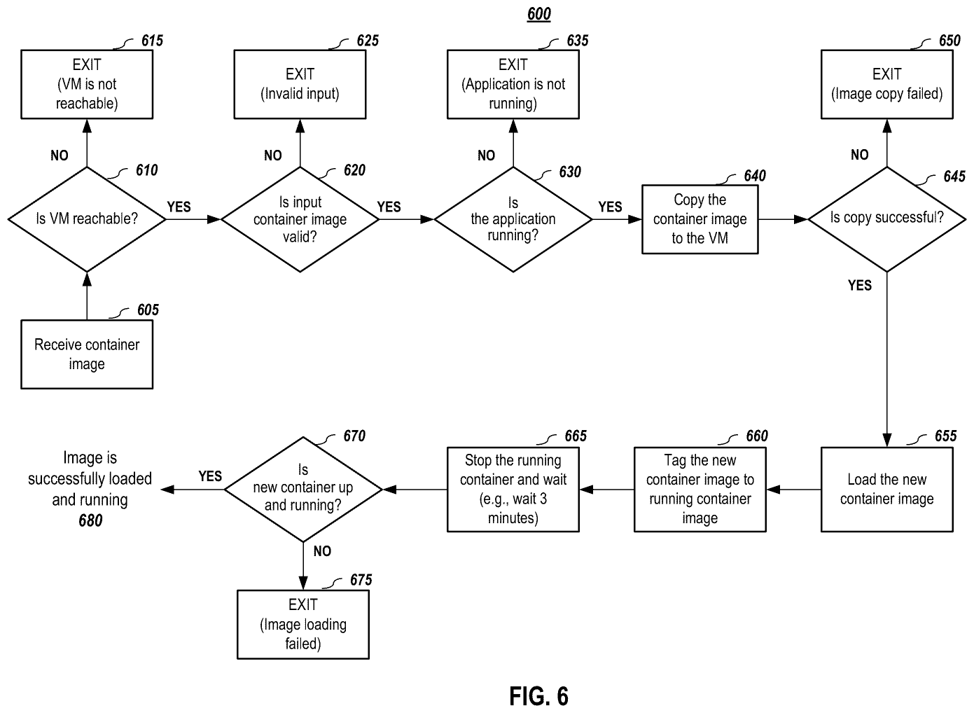

FIG. 6 depicts a methodology for software installation using a SAD system given a container or container-like software package, according to embodiments of the present disclosure.

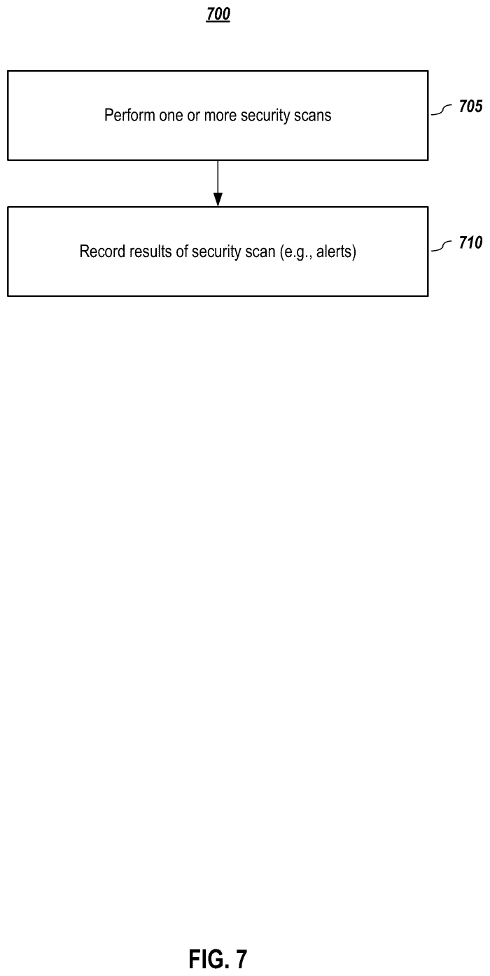

FIG. 7 depicts a methodology for performing one or more security scans as part of a software installation, according to embodiments of the present disclosure.

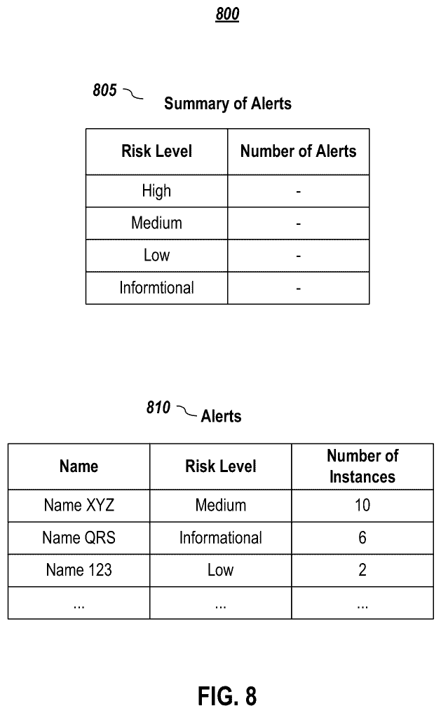

FIG. 8 graphically illustrates some example security summary results, according to embodiments of the present disclosure.

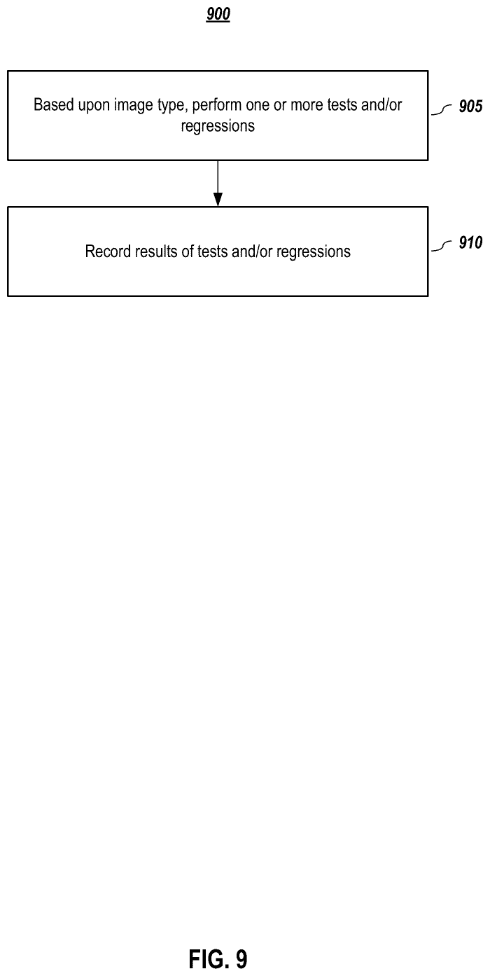

FIG. 9 depicts a methodology for performing one or more functionality tests as part of a software installation, according to embodiments of the present disclosure.

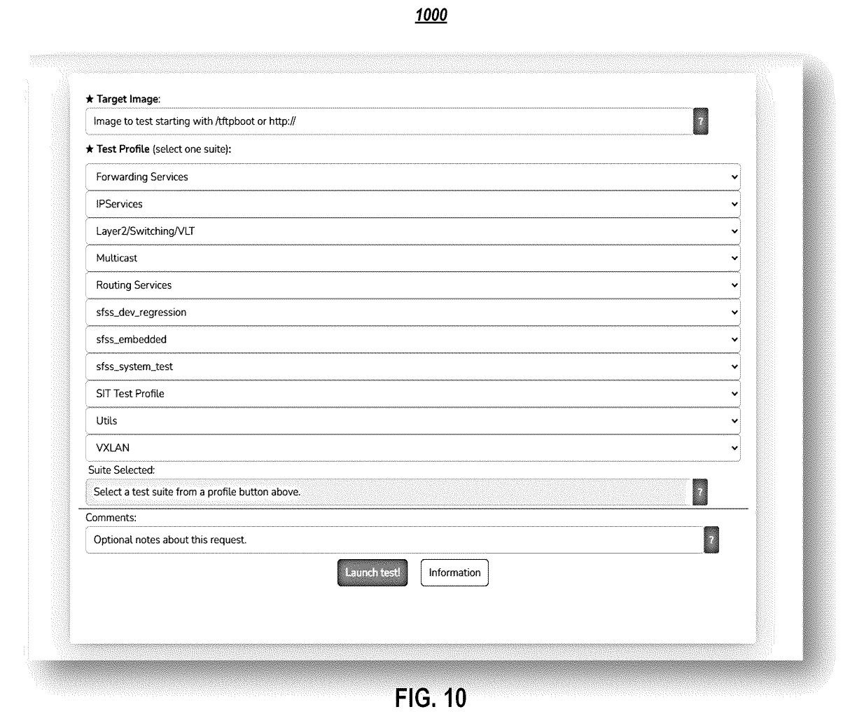

FIG. 10 graphically illustrates some example functionality test/validation results, according to embodiments of the present disclosure.

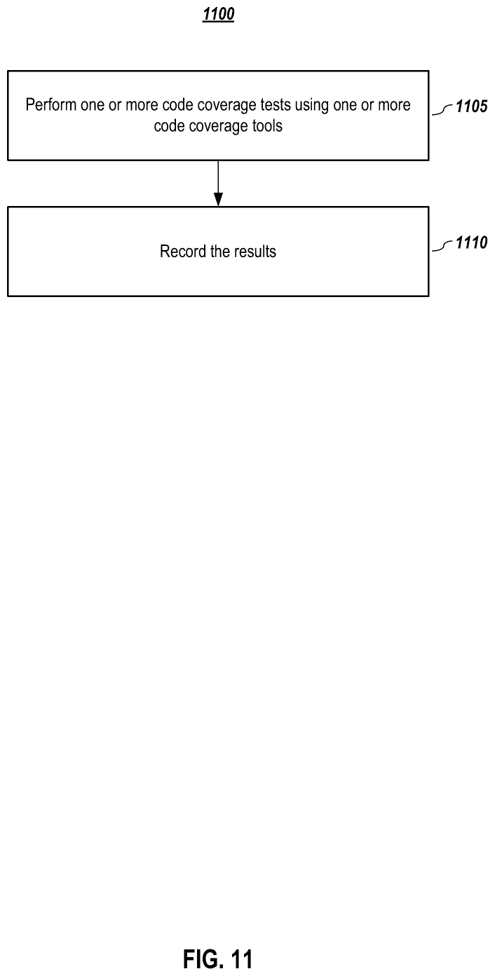

FIG. 11 depicts a methodology for performing one or more code coverage tests as part of a software installation, according to embodiments of the present disclosure.

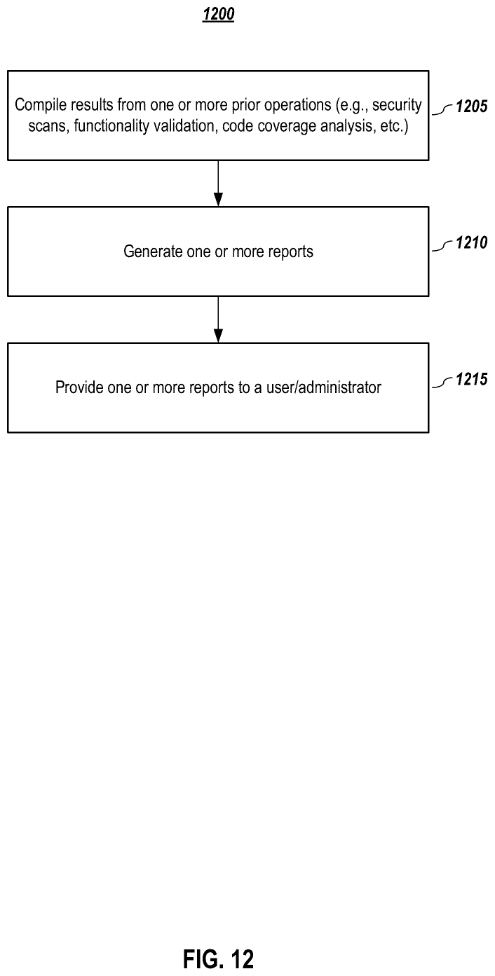

FIG. 12 depicts a methodology for report generation as part of a software installation, according to embodiments of the present disclosure.

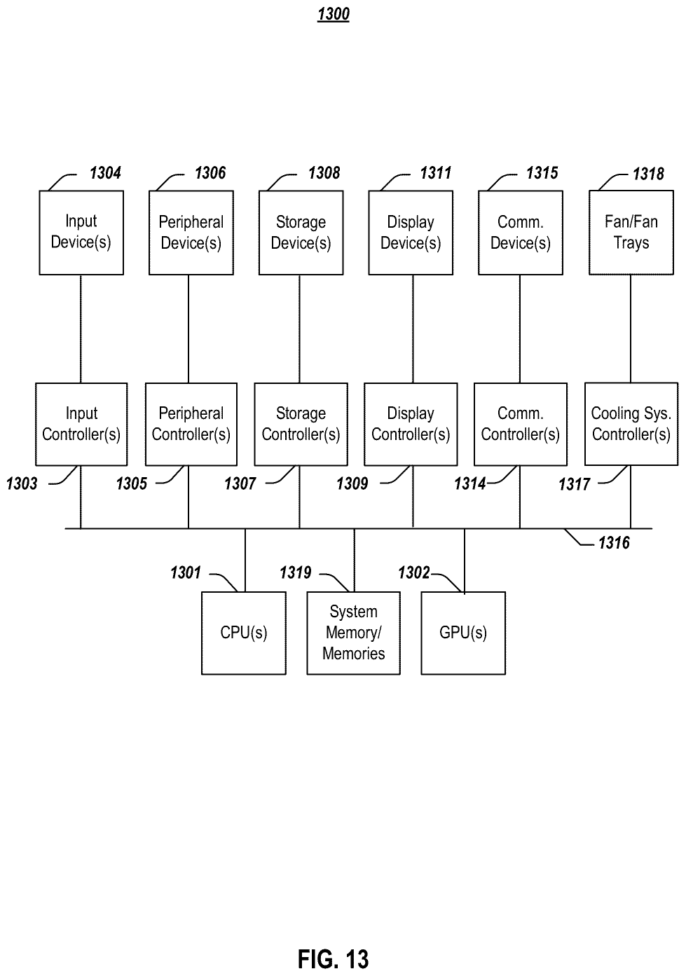

FIG. 13 depicts a simplified block diagram of an information handling system, according to embodiments of the present disclosure.

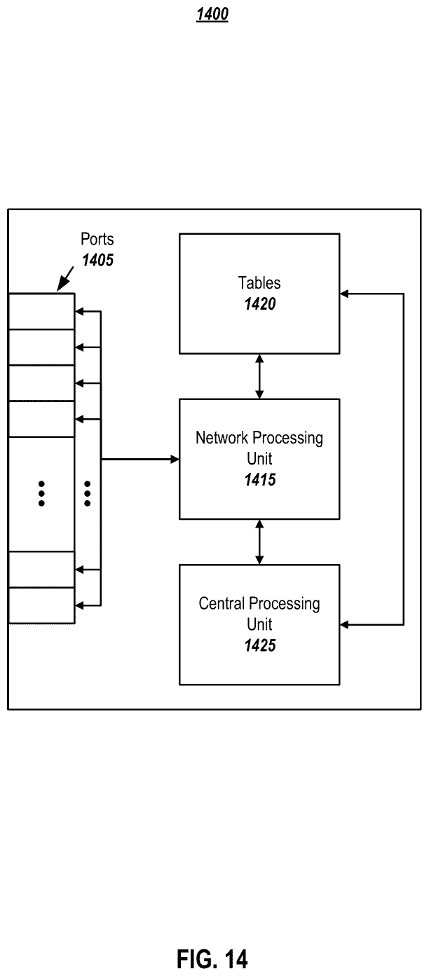

FIG. 14 depicts an alternative block diagram of an information handling system, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system/device, or a method on a tangible computer-readable medium.

Components, or modules, shown in diagrams are illustrative of exemplary embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgement, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. The terms “include,” “including,” “comprise,” “comprising,” and any of their variants shall be understood to be open terms, and any examples or lists of items are provided by way of illustration and shall not be used to limit the scope of this disclosure.

A service, function, or resource is not limited to a single service, function, or resource; usage of these terms may refer to a grouping of related services, functions, or resources, which may be distributed or aggregated. The use of memory, database, information base, data store, tables, hardware, cache, and the like may be used herein to refer to system component or components into which information may be entered or otherwise recorded. The terms “data,” “information,” along with similar terms, may be replaced by other terminologies referring to a group of one or more bits, and may be used interchangeably. The terms “packet” or “frame” shall be understood to mean a group of one or more bits. The term “frame” shall not be interpreted as limiting embodiments of the present invention to Layer 2 networks; and, the term “packet” shall not be interpreted as limiting embodiments of the present invention to Layer 3 networks. The terms “packet,” “frame,” “data,” or “data traffic” may be replaced by other terminologies referring to a group of bits, such as “datagram” or “cell.” The words “optimal,” “optimize,” “optimization,” and the like refer to an improvement of an outcome or a process and do not require that the specified outcome or process has achieved an “optimal” or peak state.

It shall be noted that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

It shall also be noted that although embodiments described herein may be within the context of software installation, aspects of the present disclosure are not so limited. Accordingly, the aspects of the present disclosure may be applied or adapted for use in other contexts.

### A. General Introduction

As noted above, manual installation of software is replete with issues. Currently, if a developer or tester wants to install and validate code changes in a software product, they must manually deploy and/or upgrade a virtual machine (VM). Given today's complex software applications or suites of applications and given the extensive use of software, deployment of software-such as new applications or updates-present significant burdens.

To further complicate matters, software updates can be in a variety of different formats or types. By way of nonlimiting illustration, software applications, such as networking software products, may support a number of different types of software images. For example, a sophisticated software product may support formats for new application and/or upgrades, such as: OVA/OVA-type software packages; QCOW/QCOW2/QCOW-type software e packages; compressed software packages, such as ZIP and DEB; container images, such as tar.gz; and other formats.

OVA (“Open Virtualization Appliance”) refers to a virtual machine (VM) image format that is used for packaging and distributing virtual appliances. A virtual appliance is a pre-configured software stack that typically includes an operating system and one or more applications, packaged together in a single VM image. OVA is a standard format that is supported by many virtualization platforms, which allows for deployment and migration of virtual appliances across different virtualization environments.

QCOW/QCOW2 (Quick EMUlator (QEMU) Copy-On-Write) is a virtual disk image format used in the QEMU virtualization environment. QEMU is an open-source virtualization software that allows for emulation and virtualization of various computer host architectures, including x86, ARM, PowerPC, and others. QEMU provides a flexible and extensible platform for running virtual machines (VMs) on a host system, enabling the execution of different operating systems, software, and applications within isolated virtual environments. QEMU is often used in combination with other virtualization technologies, such as the Kernel-based Virtual Machine (KVM) on Linux systems, to provide virtualization solutions. QCOW2 is a file format that represents a virtual hard drive or disk image for a virtual machine. The “Copy-On-Write” aspect of QCOW2 refers to a storage optimization technique used in virtualization where multiple virtual machines may share a common base image (typically referred to as the “base image”) while maintaining their own differences (typically referred to as “overlay” or “delta” images). This allows for efficient storage utilization by minimizing duplicate data and reducing disk space requirements.

QCOW2 represents version 2, which is an updated version of the original QCOW format, with improvements in terms of performance, scalability, and features. QCOW2 is commonly used in various virtualization environments and virtualization platforms that support the QEMU virtualization technology.

For software, a container refers to a lightweight and portable software package that typically encapsulates an application and its dependencies, along with runtime settings, into a single, self-contained unit. Containers utilize containerization technology, such as Docker, to package applications and their dependencies into a standardized format that can be deployed and executed on any system that supports the containerization platform. Containers are typically based on container images, which are read-only templates that include the application code, runtime libraries, and system tools needed to run the application. Containers are often used for microservices-based architectures, DevOps practices, and continuous integration/continuous deployment (CI/CD) workflows, as they allow for packaging, deployment, and scaling of applications. Containers provide a consistent and reproducible environment for applications to run, making them portable and suitable for cloud deployments, on-premises environments, and other deployment scenarios.

ZIP and DEB are file formats commonly used in the context of software distribution and packaging. ZIP is a general-purpose file format used for compression and archiving, while DEB is a specific file format used in Debian-based Linux distributions for packaging and installing software. ZIP is a widely used file format for compression and archiving files. It allows multiple files and folders to be compressed into a single archive file, which can be easily transmitted or stored. ZIP files are typically used to package software or other files for distribution, making it easier to download, share, and install software. DEB is a file format used in Debian-based Linux distributions, such as Ubuntu, for software packaging and installation. DEB files contain software packages, which are archives that contain the files and metadata needed for installing software on a Debian-based system.

“tar.gz” is a file format that combines two different techniques for file handling: tar and gzip. It is commonly used in Unix-based operating systems, including Linux, as a means of compressing and archiving files or directories. Tar, short for “tape archive,” is a utility that creates an archive of files or directories into a single file. It preserves the directory structure and file permissions of the original files, making it suitable for creating backups or transferring files while maintaining their attributes. Gzip, short for “GNU zip,” is a compression utility that reduces the size of a file by compressing its contents. It uses the gzip algorithm to compress files, resulting in smaller file sizes, which can save storage space and reduce the time required for file transfer. When combined, the “tar” command is used to create an archive of files or directories, and the “gzip” command is used to compress the resulting archive. The resulting file has the “.tar.gz” or “.tgz” extension and contains a compressed archive of the original files or directories, preserving their attributes and directory structure. To extract or unpack a tar.gz file, the “tar” and “gzip” utilities are used in combination to decompress and extract the original files or directories from the software package. Tar.gz files are commonly used for distributing software packages, as they allow for efficient compression and archiving of multiple files and directories while preserving their attributes and directory structure.

In addition to performing the upgrade/install, once the upgrade/install has completed, an administrator may manually perform additional functions such as triggering the regression suites, performing security scans, capturing the code coverage, etc. Each of these additional operations further adds to burdensomeness of the overall process, which involves multiple manual interventions.

Accordingly, embodiments herein provide a software application deployer (SAD) system or bot that can automate much of these previously manual processes. By automating the installation of new software or upgrading software, the process not only becomes less time-consuming and labor-intensive but also reduces errors and reduces delays. In one or more embodiments, a SAD bot may be used to automatically identify and deploy an application/container. A SAD bot may also be used in various scenarios such as customer environment and engineering environments. For example, in customer environments, a SAD bot may be used for Day-0 deployment, upgrade/installing of multiple applications, regressions to ensure no code/operation breakage, among other uses. In engineering environments, a SAD bot may be used for deploying/upgrading applications, validating the functionality of the application, test security vulnerabilities, capture code coverage, providing detailed reports, among other functions.

Because the SAD bot is automated, the overall process may be performed with minimal human involvement; the whole process may be one touch or zero touch. A SAD bot implementation may be considered as a one-stop solution to identify an input package type of an application and deploy the input software package based on its identified type. A user/admin need not manually identify and validate the package type. In one or more embodiments, a user/admin is not required to have any prior knowledge on the type of application or the supported environments to deploy it. Following automatic deployment of a software package by a SAD bot, in one or more embodiments, a user/admin can directly start using the installed or upgraded application via a GUI (graphical user interface)/console/SSH (secure shell for Unix).

In one or more embodiments, a SAD Bot may be a containerized tool and may be continuous integration (CI), continuous delivery/deployment (CD), and continuous testing (CT) compliant. Such a system is agile and presents a sustainable model.

In one or more embodiments, a SAD system may include functionality or integrated with one or more functional modules to detect the topology usage and create new topology whenever required.

In one or more embodiments, a SAD system may ascertain whether an upgrade has failed and may reset to prior available image if the upgrade failed.

Finally, in one or more embodiments, a SAD system may be integrated with other elements to create infra VMs, such as ESXI and Linux, to run virtualized applications.

### B. SAD Embodiments

### 1. SAD System Embodiments

FIG. 1 depicts a software application deployer (SAD) system (or bot), according to embodiments of the present disclosure. As illustrated in FIG. 1, a software application deployer (SAD) system 110 comprises two main components: an input analyzer 115 and a launcher 120. Also depicted in FIG. 1 are additional components including a security scanner 130, a functionality validator 135, a code coverage analyzer 140, and a report generator 145. It shall be noted that one or more of these additional components may be optionally present and may be integrated with the SAD bot 110 or may be separate. It shall also be noted that other components (not shown) may also be present and may also be separate from or combined with the SAD bot. The operations of the SAD bot and of these additional components are described in more detail below.

### 2. Overall Method Embodiments

Turning now to FIG. 2, depicted is a methodology for software installation using a SAD system, according to embodiments of the present disclosure. In one or more embodiments, the SAD bot 110 receives (205) a software package 105. As noted above, the software package 105 may be in any of a number of different formats and may represent a new application or an upgrade to an existing application. Examples of types of inputs may include, by way of nonlimiting examples: (1) weekly build updates (which may be in the format of OVA, QCOW2, or DEB/ZIP packages); (2) merge request (which may be in the format of DEB/ZIP packages, tar.gz packages, or container images); bug fixes for a repository (which may be in the format of tar.gz packages or container images); bug fixes for multiple repositories (which may be in the format of DEB/ZIP packages); and bug fixes for an intra VM (which may be in the format of OVA or QCOW2 package).

In one or more embodiments, the software package may have been developed using or may be applied to a development-ready platform, which may also be referred to a CI/CD process. Such software or technology stacks are equipped with the necessary tools, libraries, frameworks, and infrastructure to support software development activities. In one or more embodiments, a software package may be or may utilize a hook, which is typically a feature within a software development platform that allows developers to hook into or extend a platform's functionality to customize or enhance the development environment or process. That is, a “hook” generally refers to a mechanism that allows developers to inject custom code or behavior into an existing system or process at specific points in its execution flow. Hooks can also facilitate interoperability with other tools, frameworks, or systems, as they provide a standardized way for developers to add custom code or behavior to an execution flow.

In one or more embodiments, the input analyzer 115 receives (205) the input package and analyzes (210) the software package to determine the type of package it is. Determining the type of package may be done by ascertaining the format of the input software package. In one or more embodiments, the input analyzer 115 provides the type to the launcher module 120, which uses the identified type to apply (120) a deployment methodology that corresponds to the determined type of package. Example embodiments of deployment methodologies are discussed below with respect to FIGS. 3-6. It shall be noted that additional formats and deployments may be implemented by the launcher.

Finally, in one or more embodiments, one or more additional services (e.g., security scanning 130, functionality validation 135, code coverage analysis 140, and/or report generation 140) may be performed following launch of the installation. Example embodiments of additional service methodologies are discussed below with respect to FIGS. 7-12. It shall be noted that fewer or more services may be performed.

### 3. OVA/OVA-Type Software Package Deployment Embodiments

Following the input analyzer determining that an OVA/OVA-like software package was received, the launcher will launch a deployment methodology for OVA/OVA-like software packages. FIG. 3 depicts a methodology for software installation using a SAD system given an OVA (Open Virtualization Appliance) or OVA-like software package, according to embodiments of the present disclosure.

In one or more embodiments, an OVA/OVA-type software package and information about a target host information handling system is received (305), and a determination is made (310) whether a virtual machine on the target host information handling system is reachable. In one or more embodiments, after the reachable virtual machine has been deleted or if there is no reach virtual machine, a new virtual machine is created (320) on the target host information handling system using the OVA/OVA-type software package and initial configuration of the new virtual machine is performed (325). The resulting new virtual machine represents successful deployment (330) of the OVA/OVA-type software package.

4. QCOW/QCOW2/QCOW-like/QCOW2-like Software Package

### Deployment Embodiments

Following the input analyzer determining that a QCOW/QCOW-like/QCOW2/QCOW2-like software package was received, the launcher will launch a deployment methodology corresponding to that type of software package. FIG. 4 depicts a methodology for software installation using a SAD system given a QCOW/QCOW-like/QCOW2/QCOW2-like software package, according to embodiments of the present disclosure.

In one or more embodiments, the QCOW/QCOW-like/QCOW2/QCOW2-like software package and information about a target host information handling system is received (405), and a determination is made whether the target host information handling system possesses (410) a correct operating system (e.g., Linux OS). Responsive to the target host information handling system not having the correct operating system, deployment of the QCOW/QCOW-like/QCOW2/QCOW2-like software package on the target host information handling system may be terminated (415). In one or more embodiments, an alert indicating the error may be generated and transmitted (e.g., returned to the SAD system, sent to an administrator, etc.).

Responsive to the target host information handling system having the correct operating system, a determination is made (420) whether the target host information handling system supports virtualization. Responsive to the target host information handling system not supporting virtualization, deployment of the QCOW/QCOW-like/QCOW2/QCOW2-like software package on the target host information handling system may be terminated (425) and a corresponding alert may be generated and transmitted.

However, responsive to the target host information handling system supporting virtualization, a determination is made (430) whether a Kernel-based Virtual Machine (KVM) is on the target host information handling system. In one or more embodiments, determining whether a KVM is on the target host information handling system may also include determining whether one or more prerequisites are also met (e.g., whether an internal bridge interface is present or not).

In one or more embodiments, responsive to a KVM not being on the target host information handling system, a KVM may be installed (435) on the target host information handling system a KVM. Responsive to the KVM installation on the target host information handling system not being successful, deployment of the QCOW/QCOW-like/QCOW2/QCOW2-like software package on the target host information handling system may be terminated (445) and a corresponding alert may be generated and transmitted.

Responsive to the KVM installation on the target host information handling system being successful, a determination is made (450) whether a virtual machine already exists on the target host information handling system. In one or more embodiments, if a virtual machine already exists on the target host information handling system, the virtual machine is deleted (455).

In one or more embodiments, after deleting the existing virtual machine (if it existed) or if no virtual machine already existed on the target host information handling system, a virtual machine is created (460) using the QCOW/QCOW-like/QCOW2/QCOW2-like software package, and initial configuration of the virtual machine is performed (465), if needed. The resulting new virtual machine represents successful deployment (470) of the QCOW/QCOW-like/QCOW2/QCOW2-like software package.

### 5. Software Package Deployment Embodiments

Following the input analyzer determining that an upgrade software package was received, the launcher will launch a deployment methodology corresponding to that type of software package. FIG. 5 depicts a methodology for software installation using a SAD system given an upgrade software package, according to embodiments of the present disclosure.

In one or more embodiments, the upgrade software package is received (505), which may also include information about a target host information handling system. In one or more embodiments, a determination is made (510) whether the target host information handling system has a virtual machine that is reachable. Responsive to the target host information handling system not having a virtual machine that is reachable, deployment of the upgrade software package on the target host information handling system may be terminated (515). In one or more embodiments, an alert indicating the error may be generated and transmitted (e.g., returned to the SAD system, sent to an administrator, etc.).

Responsive to the target host information handling system having a virtual machine that is reachable, a determination may be made (520) whether the application is running at the target host information handling system. If the application is not running at the target host information handling system, deployment of the upgrade software package on the target host information handling system may be terminated (525), and an alert indicating the error may be generated and transmitted.

Responsive to the application running at the target host information handling system, a determination may be made (530) whether the upgrade software package is a valid input version. If the upgrade software package is not a valid input version, deployment of the upgrade software package on the target host information handling system may be terminated (535), and an alert indicating the error may be generated and transmitted. However, responsive to the upgrade software package being a valid input version, the upgrade package is copied (540) to the virtual machine that is reachable at the target host information handling system.

In one or more embodiments, one or more files related to the upgrade software package (in which the one or more files may be the upgrade software package or may be a derivation therefrom) are copied onto the target host information handling system. If copying (550) the one or more files related to the upgrade software package onto the target host information handling system was not unsuccessful, deployment of the upgrade software package on the target host information handling system may be terminated (545), and an alert indicating the error may be generated and transmitted.

However, responsive to copying (550) one or more files related to the upgrade software package on the target host information handling system being successful, one or more files for the upgrade software package may be added (555) to the virtual machine. In one or more embodiments, the one or more files may be added to the virtual machine by using a POST REST API (application programming interface).

A check may be made (560) to determine whether the downloading/adding was successful. In one or more embodiments, the check may also include checking whether any staging (if any) was successfully implemented. If adding the one or more files for the upgrade software package to the virtual machine was not successful (or if the staging was not successful for embodiments involve staging), deployment of the upgrade software package on the target host information handling system may be terminated (565), and an alert indicating the error may be generated and transmitted.

If adding one or more files for the upgrade software package to the virtual machine was successful, the virtual machine on the target host information handling system may be upgraded (570) using the one or more files. In one or more embodiments, the upgrading may be performed by using a PUT REST API.

In one or more embodiments, a check may be performed (575) to determine whether the VM with the upgraded version is running (575). In one or more embodiments, a certain time period (e.g., 5 minutes) may be waited following upgrade (570) before performing this check (575). If an upgraded version VM is not running on the target host information handling system, deployment of the upgrade software package on the target host information handling system may be terminated (580) as the upgrade as failed, and an alert indicating the error may be generated and transmitted.

If an upgraded version VM is running on the target host information handling system, deployment of the upgrade software package on the target host information handling system may be deemed (585) successful.

### 6. Container/Container-Type Software Package Deployment Embodiments

Following the input analyzer determining that an upgrade software package was received, the launcher will launch a deployment methodology corresponding to that type of software package. FIG. 6 depicts a methodology for software installation using a SAD system given a container or container-like software package, according to embodiments of the present disclosure.

In one or more embodiments, the container/container-like software package is received (605), which may also include information about a target host information handling system. In one or more embodiments, a determination is made (610) whether the target host information handling system has a virtual machine that is reachable. Responsive to the target host information handling system not having a virtual machine that is reachable, deployment of the container/container-like software package on the target host information handling system may be terminated (615). In one or more embodiments, an alert indicating the error may be generated and transmitted (e.g., returned to the SAD system, sent to an administrator, etc.).

Responsive to the target host information handling system having a virtual machine that is reachable, a determination may be made (620) whether the container/container-like image is valid. If the container/container-like software package is not a valid input version, deployment of the container/container-like software package on the target host information handling system may be terminated (625), and an alert indicating the error may be generated and transmitted.

However, responsive to the container/container-like software package being a valid input version, a determination may be made (630) whether the application is running on the target host information handling system. If the application is not running at the target host information handling system, deployment of the container/container-like software package on the target host information handling system may be terminated (635), and an alert indicating the error may be generated and transmitted. In one or more embodiments, responsive to the application running on the target host information handling system, the container/container-type image is copied (640) to the virtual machine on the target host information handling system as a new container/container-type image.

In one or more embodiments, a check may be made (645) to ascertain whether the copying was successful. Responsive to copying the container/container-type image to the virtual machine on the target host information handling system not being successful, deployment of the container/container-like software package on the target host information handling system may be terminated (650), and an alert indicating the error may be generated and transmitted.

Responsive to copying the container/container-type image to the virtual machine on the target host information handling system being successful, the deployment process may proceed. The copied image may be used to load (655) the new container/container-type image, and the new container/container-type image may be tagged (660) to a corresponding running container image. In one or more embodiments, the running container image may be stopped (665).

A check may be performed (670) to determine whether the new container is running. In one or more embodiments, a certain time period (e.g., 3-5 minutes) may be waited following stopping the running container (665) before performing this check (670). If the new container is not running on the target host information handling system, deployment of the upgrade software package on the target host information handling system may be terminated (675), and an alert indicating the error may be generated and transmitted.

However, if a new container is running on the target host information handling system, deployment of the container/container-like software package on the target host information handling system may be deemed (680) successful.

### 7. Additional Services Embodiments

a. Security Scanning Embodiments

FIG. 7 depicts a methodology for performing security operations as part of a software installation, according to embodiments of the present disclosure. In one or more embodiments, one or more security scans of the deployed software package or any portion thereof may be performed (705). Security scans may be of the type typically performed, such as malware, antivirus, etc. Alternatively, or additionally, in one or more embodiments, specific security scans related to the software package or the application may be performed.

In one or more embodiments, one or more reports of the security scan(s) may be generated (710). FIG. 8 graphically illustrates some example security summary results 800, according to embodiments of the present disclosure. As depicted in FIG. 8, a summary of security alerts 805 may be presented, which may include levels of security risk. In one or more embodiments, a more detailed set of alerts 805 may be additionally or alternatively provided. The detailed list may identify a specific set of risks by name, their risk levels, and the number of occurrences or instances of such.

The security scans may be associated to the SAD system and may be a one-time activity related to a deployment or may be performed at different times as well.

In one or more embodiments, examples of security scans associated with the SAD system may include (but are not limited to):
NMAP: Port scan to detect the open ports;
OpenVas: Vulnerability scanners;
Nessus: Vulnerability scanners;
Commix: Open-source penetration testing tool;
OWASP ZAP: Web application scanner to improve the security of product; and
THC HYDRA: Parallelized network login cracker for penetration testing.

One skilled in the art shall recognize that other security scans and operations may be performed.

b. Functionality Validation Embodiments

FIG. 9 depicts a methodology for performing one or more functionality tests as part of a software installation, according to embodiments of the present disclosure. In one or more embodiments, based upon image type, one or more tests and/or regressions may be performed (905) or triggered upon deployment. In one or more embodiments, for fresh installations, sanity/full regression suites may be mapped; and for upgrade applications and/or containers, feature-specific test suites may be mapped. One skilled in the art shall recognize that number of functionality tests and validations may be performed.

In one or more embodiments, one or more reports of the results may be generated (910). FIG. 10 graphically illustrates some example functionality test/validation results, according to embodiments of the present disclosure.

c. Code Coverage Analysis Embodiments

In one or more embodiments, code coverage tools may be integrated with a SAD system embodiment. In one or more embodiments, if the code coverage is enabled in the image, the lines covered in source code during functionality validation may be automatically captured and sent to report generator.

FIG. 11 depicts a methodology for performing one or more code coverage tests as part of a software installation, according to embodiments of the present disclosure. In one or more embodiments, one or more code coverage tests may be performed (1105) using one or more code coverage tools. The results from one or more tests may be compiled (1110), and the results recorded for reporting.

d. Report Generation Embodiments

FIG. 12 depicts a methodology for report generation as part of a software installation, according to embodiments of the present disclosure. In one or more embodiments, the results from one or more prior operations (e.g., security scans, functionality validation, code coverage analysis, etc.) may be compiled (1205), and they may be used to generate (1210) one or more reports, which may be considered as reports related to the status of the deployment. In one or more embodiments, the system may provide a centralized reporting feature for an administrator/user. The reporting functionality may also include handling and/or displaying any alerts that the deployment terminated before successful completion of the deployment of the software application. One skilled in the art shall recognize that other reporting functionality and features may be provided.

### C. Computing/Information Handling System Embodiments

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smart phone, phablet, tablet, etc.), smart watch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drives, solid state drive, or both), one or more network ports for communicating with external devices as well as various input and output (I/O) devices. The computing system may also include one or more buses operable to transmit communications between the various hardware components.

FIG. 13 depicts a simplified block diagram of an information handling system (or computing system), according to embodiments of the present disclosure. It will be understood that the functionalities shown for system 1300 may operate to support various embodiments of a computing system—although it shall be understood that a computing system may be differently configured and include different components, including having fewer or more components as depicted in FIG. 13.

As illustrated in FIG. 13, the computing system 1300 includes one or more CPUs 1301 that provides computing resources and controls the computer. CPU 1301 may be implemented with a microprocessor or the like and may also include one or more graphics processing units (GPU) 1302 and/or a floating-point coprocessor for mathematical computations. In one or more embodiments, one or more GPUs 1302 may be incorporated within the display controller 1309, such as part of a graphics card or cards. The system 1300 may also include a system memory 1319, which may comprise RAM, ROM, or both.

A number of controllers and peripheral devices may also be provided, as shown in FIG. 13. An input controller 1303 represents an interface to various input device(s) 1304, such as a keyboard, mouse, touchscreen, stylus, microphone, camera, trackpad, display, etc. The computing system 1300 may also include a storage controller 1307 for interfacing with one or more storage devices 1308 each of which includes a storage medium such as magnetic tape or disk, or an optical medium that might be used to record programs of instructions for operating systems, utilities, and applications, which may include embodiments of programs that implement various aspects of the present disclosure. Storage device(s) 1308 may also be used to store processed data or data to be processed in accordance with the disclosure. The system 1300 may also include a display controller 1309 for providing an interface to a display device 1311, which may be a cathode ray tube (CRT) display, a thin film transistor (TFT) display, organic light-emitting diode, electroluminescent panel, plasma panel, or any other type of display. The computing system 1300 may also include one or more peripheral controllers or interfaces 1305 for one or more peripherals 1306. Examples of peripherals may include one or more printers, scanners, input devices, output devices, sensors, and the like. A communications controller 1314 may interface with one or more communication devices 1315, which enables the system 1300 to connect to remote devices through any of a variety of networks including the Internet, a cloud resource (e.g., an Ethernet cloud, a Fibre Channel over Ethernet (FCOE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 1300 comprises one or more fans or fan trays 1318 and a cooling subsystem controller or controllers 1317 that monitors thermal temperature(s) of the system 1300 (or components thereof) and operates the fans/fan trays 1318 to help regulate the temperature.

In the illustrated system, all major system components may connect to a bus 1316, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

FIG. 14 depicts an alternative block diagram of an information handling system, according to embodiments of the present disclosure. It will be understood that the functionalities shown for system 1400 may operate to support various embodiments of the present disclosure—although it shall be understood that such system may be differently configured and include different components, additional components, or fewer components.

The information handling system 1400 may include a plurality of I/O ports 1405, a network processing unit (NPU) 1415, one or more tables 1420, and a CPU 1425. The system includes a power supply (not shown) and may also include other components, which are not shown for sake of simplicity.

In one or more embodiments, the I/O ports 1405 may be connected via one or more cables to one or more other network devices or clients. The network processing unit 1415 may use information included in the network data received at the node 1400, as well as information stored in the tables 1420, to identify a next device for the network data, among other possible activities. In one or more embodiments, a switching fabric may then schedule the network data for propagation through the node to an egress port for transmission to the next destination.

Aspects of the present disclosure may be encoded upon one or more non-transitory computer-readable media with instructions for one or more processors or processing units to cause steps to be performed. It shall be noted that the one or more non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that have computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as compact discs (CDs) and holographic devices; magneto-optical media; and hardware devices that are specially configured to store or to store and execute program code, such as ASICs, PLDs, flash memory devices, other non-volatile memory devices (such as 3D XPoint-based devices), ROM, and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A computer-implemented method for automatically deploying a software application on a target host information handling system, the method comprising:
responsive to receiving, at a software application deployer (SAD), a software package:
analyzing the software package, using the SAD, to determine a type of software package;
responsive to the SAD determining the type of the software package, launching, via the SAD, a deployment method corresponding to the type of the package to install the software package on the target host information handling system; and
issuing a report related to status of deployment of the software package.

2. The computer-implemented method of claim 1 wherein:
responsive to the software package being an OVA/OVA-like software package, causing steps to be performed comprising:
determining whether a virtual machine on the target host information handling system is reachable;
responsive to the virtual machine being reachable, deleting the virtual machine;
creating a new virtual machine on the target information handling system using the OVA/OVA-like software package; and
performing an initial configuration of the new virtual machine.

3. The computer-implemented method of claim 1 wherein:
responsive to the software package being a QCOW/QCOW-like/QCOW2/QCOW2-like software package, causing steps to be performed comprising:
determining whether the target host information handling system has a correct operating system;
responsive to the target host information handling system not having the correct operating system, terminating deployment of the QCOW/QCOW-like/QCOW2/QCOW2-like software package on the target host information handling system;
responsive to the target host information handling system having the correct operating system, determining whether the target host information handling system supports virtualization;
responsive to the target host information handling system not supporting virtualization, terminating deployment of the QCOW/QCOW-like/QCOW2/QCOW2-like software package on the target host information handling system;
responsive to the target host information handling system supporting virtualization, determining whether a Kernel-based Virtual Machine (KVM) is on the target host information handling system;
responsive to a KVM not being on the target host information handling system:
installing on the target host information handling system a KVM; and
responsive to the KVM installation on the target host information handling system not being successful, terminating deployment of the QCOW/QCOW-like/QCOW2/QCOW2-like software package on the target host information handling system;
determining whether a virtual machine already exists on the target host information handling system;
responsive to determining that a virtual machine already exists on the target host information handling system, deleting the virtual machine;
creating a virtual machine using the QCOW/QCOW-like/QCOW2/QCOW2-like software package; and
performing initial configuration of the virtual machine.

4. The computer-implemented method of claim 1 wherein:
responsive to the software package being an upgrade software package for an application, causing steps to be performed comprising:
determining whether the target host information handling system has a virtual machine that is reachable;
responsive to the target host information handling system not having a virtual machine that is reachable, terminating deployment of the upgrade software package on the target host information handling system;
responsive to the target host information handling system having a virtual machine that is reachable, determining whether the application is running at the target host information handling system;
responsive to the application not running at the target host information handling system, terminating deployment of the upgrade software package on the target host information handling system;
responsive to the application running at the target host information handling system, determining whether the upgrade software package is a valid input version;
responsive to the upgrade software package not being a valid input version, terminating deployment of the upgrade software package on the target host information handling system;
responsive to the upgrade software package being a valid input version, copying one or more files related to the upgrade software package on the target host information handling system;
responsive to copying one or more files related to the upgrade software package on the target host information handling system being unsuccessful, terminating deployment of the upgrade software package on the target host information handling system;
responsive to copying one or more files related to the upgrade software package on the target host information handling system being successful, adding one or more files for the upgrade software package to the virtual machine;
responsive to adding the one or more files for the upgrade software package to the virtual machine not being successful, terminating deployment of the upgrade software package on the target host information handling system; and
responsive to adding the one or more files for the upgrade software package to the virtual machine being successful, upgrading the virtual machine on the target host information handling system using the one or more files.

5. The computer-implemented method of claim 1 wherein:
responsive to the software package being a container/container-type image for an application, causing steps to be performed comprising:
determining whether the target host information handling system has a virtual machine that is reachable;
responsive to the target host information handling system not having a virtual machine that is reachable, terminating deployment of the container/container-type image on the target host information handling system;
responsive to the target host information handling system having a virtual machine that is reachable, determining whether the container/container-type image is valid;
responsive to the container/container-type image not being valid, terminating deployment of the container/container-type image on the target host information handling system;
responsive to the container/container-type image being valid, determining whether the application is running on the target host information handling system;
responsive to the application not running on the target host information handling system, terminating deployment of the container/container-type image on the target host information handling system;
responsive to the application running on the target host information handling system, copying the container/container-type image to the virtual machine on the target host information handling system as a new container/container-type image;
responsive to copying the container/container-type image to the virtual machine on the target host information handling system not being successful, terminating deployment of the container/container-type image on the target host information handling system; and
responsive to copying the container/container-type image to the virtual machine on the target host information handling system being successful:
loading the new container/container-type image;
tagging the new container/container-type image to a corresponding running container image;
stopping the running container image;
determining whether the new container/container-type image is running;
responsive to the new container/container-type image not running, terminating deployment of the container/container-type image on the target host information handling system; and
responsive to the new container/container-type image running, deeming the container/container-type image as successfully deployed on the target host information handling system.

6. The computer-implemented method of claim 1 further comprising performing at least one of the following steps:
performing one or more security scans of the deployed software application;
performing one or more functionality validation tests of the deployed software application; and
performing one or more code coverage analyses.

7. The computer-implemented method of claim 1 wherein the step of issuing a report related to the launching of the deployment method of the software package comprises one or more of:
issuing an alert that the deployment terminated before successful completion of the deployment of the software application;
providing results from one or more security scans of the deployed software application;
providing results from one or more functionality validation tests of the deployed software application; and
providing results from one or more code coverage analyses of the deployed software application.

8. An information handling system comprising:
one or more processors; and
a non-transitory computer-readable medium or media comprising one or more sets of instructions which, when executed by at least one of the one or more processors, causes steps to be performed comprising:
responsive to receiving, at a software application deployer (SAD), a software package related to a software application for a target host information handling system:
analyzing the software package, using the SAD, to determine a type of software package; and
responsive to the SAD determining the type of the software package, launching, via the SAD, a deployment method corresponding to the type of the package to install the software package on the target host information handling system.

9. The information handling system of claim 8 wherein the non-transitory computer-readable medium or media further comprises one or more sets of instructions which, when executed by at least one of the one or more processors, causes steps to be performed comprising:
responsive to the software package being an OVA/OVA-like software package, causing steps to be performed comprising:
determining whether a virtual machine on the target host information handling system is reachable;
responsive to the virtual machine being reachable, deleting the virtual machine;
creating a new virtual machine on the target information handling system using the OVA/OVA-like software package; and
performing an initial configuration of the new virtual machine.

10. The information handling system of claim 8 wherein the non-transitory computer-readable medium or media further comprises one or more sets of instructions which, when executed by at least one of the one or more processors, causes steps to be performed comprising:
responsive to the software package being a QCOW/QCOW-like/QCOW2/QCOW2-like software package, causing steps to be performed comprising:
determining whether the target host information handling system has a correct operating system;
responsive to the target host information handling system not having the correct operating system, terminating deployment of the QCOW/QCOW-like/QCOW2/QCOW2-like software package on the target host information handling system;
responsive to the target host information handling system having the correct operating system, determining whether the target host information handling system supports virtualization;
responsive to the target host information handling system not supporting virtualization, terminating deployment of the QCOW/QCOW-like/QCOW2/QCOW2-like software package on the target host information handling system;
responsive to the target host information handling system supporting virtualization, determining whether a Kernel-based Virtual Machine (KVM) is on the target host information handling system;
responsive to a KVM not being on the target host information handling system:
installing on the target host information handling system a KVM; and
responsive to the KVM installation on the target host information handling system not being successful, terminating deployment of the QCOW/QCOW-like/QCOW2/QCOW2-like software package on the target host information handling system;
determining whether a virtual machine already exists on the target host information handling system;
responsive to determining that a virtual machine already exists on the target host information handling system, deleting the virtual machine;
creating a virtual machine using the QCOW/QCOW-like/QCOW2/QCOW2-like software package; and
performing initial configuration of the virtual machine.

11. The information handling system of claim 8 wherein the non-transitory computer-readable medium or media further comprises one or more sets of instructions which, when executed by at least one of the one or more processors, causes steps to be performed comprising:
responsive to the software package being an upgrade software package for an application, causing steps to be performed comprising:
determining whether the target host information handling system has a virtual machine that is reachable;
responsive to the target host information handling system not having a virtual machine that is reachable, terminating deployment of the upgrade software package on the target host information handling system;
responsive to the target host information handling system having a virtual machine that is reachable, determining whether the application is running at the target host information handling system;
responsive to the application not running at the target host information handling system, terminating deployment of the upgrade software package on the target host information handling system;
responsive to the application running at the target host information handling system, determining whether the upgrade software package is a valid input version;
responsive to the upgrade software package not being a valid input version, terminating deployment of the upgrade software package on the target host information handling system;
responsive to the upgrade software package being a valid input version, copying one or more files related to the upgrade software package on the target host information handling system;
responsive to copying one or more files related to the upgrade software package on the target host information handling system being unsuccessful, terminating deployment of the upgrade software package on the target host information handling system;
responsive to copying one or more files related to the upgrade software package on the target host information handling system being successful, adding one or more files for the upgrade software package to the virtual machine;
responsive to adding the one or more files for the upgrade software package to the virtual machine not being successful, terminating deployment of the upgrade software package on the target host information handling system; and
responsive to adding the one or more files for the upgrade software package to the virtual machine being successful, upgrading the virtual machine on the target host information handling system using the one or more files.

12. The information handling system of claim 8 wherein the non-transitory computer-readable medium or media further comprises one or more sets of instructions which, when executed by at least one of the one or more processors, causes steps to be performed comprising:
responsive to the software package being a container/container-type image for an application, causing steps to be performed comprising:
determining whether the target host information handling system has a virtual machine that is reachable;
responsive to the target host information handling system not having a virtual machine that is reachable, terminating deployment of the container/container-type image on the target host information handling system;
responsive to the target host information handling system having a virtual machine that is reachable, determining whether the container/container-type image is valid;
responsive to the container/container-type image not being valid, terminating deployment of the container/container-type image on the target host information handling system;
responsive to the container/container-type image being valid, determining whether the application is running on the target host information handling system;
responsive to the application not running on the target host information handling system, terminating deployment of the container/container-type image on the target host information handling system;
responsive to the application running on the target host information handling system, copying the container/container-type image to the virtual machine on the target host information handling system as a new container/container-type image;
responsive to copying the container/container-type image to the virtual machine on the target host information handling system not being successful, terminating deployment of the container/container-type image on the target host information handling system; and
responsive to copying the container/container-type image to the virtual machine on the target host information handling system being successful:
loading the new container/container-type image;
tagging the new container/container-type image to a corresponding running container image;
stopping the running container image;
determining whether the new container/container-type image is running;
responsive to the new container/container-type image not running, terminating deployment of the container/container-type image on the target host information handling system; and
responsive to the new container/container-type image running, deeming the container/container-type image as successfully deployed on the target host information handling system.

13. The information handling system of claim 8 wherein the non-transitory computer-readable medium or media further comprises one or more sets of instructions which, when executed by at least one of the one or more processors, causes at least one of the following steps to be performed comprising:
performing one or more security scans of the deployed software application;
performing one or more functionality validation tests of the deployed software application; and
performing one or more code coverage analyses.

14. The information handling system of claim 8 wherein the non-transitory computer-readable medium or media further comprises one or more sets of instructions which, when executed by at least one of the one or more processors, causes at least one of the following steps to be performed comprising:
issuing a report related to the launching of the deployment method of the software package.

15. A non-transitory computer-readable medium or media comprising one or more sequences of instructions which, when executed by at least one processor, causes steps to be performed comprising:
responsive to receiving, at a software application deployer (SAD), a software package related to a software application for a target host information handling system:
analyzing the software package, using the SAD, to determine a type of software package; and
responsive to the SAD determining the type of the software package, launching, via the SAD, a deployment method corresponding to the type of the package to install the software package on the target host information handling system.

16. The non-transitory computer-readable medium or media of claim 15 further comprises one or more sets of instructions which, when executed by at least one of the one or more processors, causes steps to be performed comprising:
responsive to the software package being an OVA/OVA-like software package, causing steps to be performed comprising:
determining whether a virtual machine on the target host information handling system is reachable;
responsive to the virtual machine being reachable, deleting the virtual machine;
creating a new virtual machine on the target information handling system using the OVA/OVA-like software package; and
performing an initial configuration of the new virtual machine.

17. The non-transitory computer-readable medium or media of claim 15 further comprises one or more sets of instructions which, when executed by at least one of the one or more processors, causes steps to be performed comprising:
responsive to the software package being a QCOW/QCOW-like/QCOW2/QCOW2-like software package, causing steps to be performed comprising:
determining whether the target host information handling system has a correct operating system;
responsive to the target host information handling system not having the correct operating system, terminating deployment of the QCOW/QCOW-like/QCOW2/QCOW2-like software package on the target host information handling system;
responsive to the target host information handling system having the correct operating system, determining whether the target host information handling system supports virtualization;
responsive to the target host information handling system not supporting virtualization, terminating deployment of the QCOW/QCOW-like/QCOW2/QCOW2-like software package on the target host information handling system;
responsive to the target host information handling system supporting virtualization, determining whether a Kernel-based Virtual Machine (KVM) is on the target host information handling system;
responsive to a KVM not being on the target host information handling system:
installing on the target host information handling system a KVM; and
responsive to the KVM installation on the target host information handling system not being successful, terminating deployment of the QCOW/QCOW-like/QCOW2/QCOW2-like software package on the target host information handling system;
determining whether a virtual machine already exists on the target host information handling system;
responsive to determining that a virtual machine already exists on the target host information handling system, deleting the virtual machine;
creating a virtual machine using the QCOW/QCOW-like/QCOW2/QCOW2-like software package; and
performing initial configuration of the virtual machine.

18. The non-transitory computer-readable medium or media of claim 15 further comprises one or more sets of instructions which, when executed by at least one of the one or more processors, causes steps to be performed comprising:
responsive to the software package being an upgrade software package for an application, causing steps to be performed comprising:
determining whether the target host information handling system has a virtual machine that is reachable;
responsive to the target host information handling system not having a virtual machine that is reachable, terminating deployment of the upgrade software package on the target host information handling system;
responsive to the target host information handling system having a virtual machine that is reachable, determining whether the application is running at the target host information handling system;
responsive to the application not running at the target host information handling system, terminating deployment of the upgrade software package on the target host information handling system;
responsive to the application running at the target host information handling system, determining whether the upgrade software package is a valid input version;
responsive to the upgrade software package not being a valid input version, terminating deployment of the upgrade software package on the target host information handling system;
responsive to the upgrade software package being a valid input version, copying one or more files related to the upgrade software package on the target host information handling system;
responsive to copying one or more files related to the upgrade software package on the target host information handling system being unsuccessful, terminating deployment of the upgrade software package on the target host information handling system;
responsive to copying one or more files related to the upgrade software package on the target host information handling system being successful, adding one or more files for the upgrade software package to the virtual machine;
responsive to adding the one or more files for the upgrade software package to the virtual machine not being successful, terminating deployment of the upgrade software package on the target host information handling system; and
responsive to adding the one or more files for the upgrade software package to the virtual machine being successful, upgrading the virtual machine on the target host information handling system using the one or more files.

19. The non-transitory computer-readable medium or media of claim 15 further comprises one or more sets of instructions which, when executed by at least one of the one or more processors, causes steps to be performed comprising:
responsive to the software package being a container/container-type image for an application, causing steps to be performed comprising:
determining whether the target host information handling system has a virtual machine that is reachable;
responsive to the target host information handling system not having a virtual machine that is reachable, terminating deployment of the container/container-type image on the target host information handling system;
responsive to the target host information handling system having a virtual machine that is reachable, determining whether the container/container-type image is valid;
responsive to the container/container-type image not being valid, terminating deployment of the container/container-type image on the target host information handling system;
responsive to the container/container-type image being valid, determining whether the application is running on the target host information handling system;
responsive to the application not running on the target host information handling system, terminating deployment of the container/container-type image on the target host information handling system;
responsive to the application running on the target host information handling system, copying the container/container-type image to the virtual machine on the target host information handling system as a new container/container-type image;
responsive to copying the container/container-type image to the virtual machine on the target host information handling system not being successful, terminating deployment of the container/container-type image on the target host information handling system; and
responsive to copying the container/container-type image to the virtual machine on the target host information handling system being successful:
loading the new container/container-type image;
tagging the new container/container-type image to a corresponding running container image;
stopping the running container image;
determining whether the new container/container-type image is running;
responsive to the new container/container-type image not running, terminating deployment of the container/container-type image on the target host information handling system; and
responsive to the new container/container-type image running, deeming the container/container-type image as successfully deployed on the target host information handling system.

20. The non-transitory computer-readable medium or media of claim 15 comprises one or more sets of instructions which, when executed by at least one of the one or more processors, causes at least one of the following steps to be performed comprising:
issuing an alert that the deployment terminated before successful completion of the deployment of the software application;
providing results from one or more security scans of the deployed software application;
providing results from one or more functionality validation tests of the deployed software application; and
providing results from one or more code coverage analyses of the deployed software application.
